(19) United States
(12) Patent Application Publication
(10) Pub. No.: US 2014/0291261 A1
(43) Pub. Date: Oct. 2, 2014

(54) RECYCLING FILTRATE TO INLET DURING BACKWASHING

(71) Applicant: David Kan Yee, West Bloomfield, MI (US)

(72) Inventor: David Kan Yee, West Bloomfield, MI (US)

(73) Assignee: EATON CORPORATION, Cleveland, OH (US)

(21) Appl. No.: 13/855,085

(22) Filed: Apr. 2, 2013

(51) Int. Cl. C02F 1/00

(52) U.S. Cl. CPC C02F 1/001
USPC 210/791; 210/196

(57) ABSTRACT

A fluid filtering system with backwashing, particularly for ballast tanks, employing a pump with its inlet connected to receive fluid to be filtered and the outlet of the pump to a unified filtering vessel with apparatus for sequentially backwashing individual filter media elements and connecting the backwash to a drain. The unified filtering vessel has a filtrate outlet connected through a valve for filtering flow to/from ballast tanks. The filtrate outlet is also connected through another valve to the inlet of the pump for including clean filtrate in the backwashing.

### BACKGROUND

The present disclosure relates to filtration of fluids, such as seawater, which may be stored in ballast tanks aboard a seagoing vessel. Filtrations systems are provided onboard seagoing vessels equipped with ballast tanks to prevent entrance of unwanted inorganic material and organic species into the ballast tanks. This has been found particularly necessary where seagoing vessels transit bodies of fresh water before entering port such that discharge of seawater into the fresh water does not transport unwanted organic marine life into the fresh water.

Where such filtration systems have been employed for seawater ballasts, a pressure vessel having disposed therein a plurality of replaceable filter media elements has been employed. Heretofore, the pressure vessel has been provided with a backwashing system which permitted the individual filter media elements to be backwashed sequentially without interrupting filtration flow through the remaining filter media elements. An example of a known seawater filtering system 10 is shown in FIG. 3 as having a pump 11 with its inlet connected through a valve to a discharge line 12 from the vessel ballast tanks; and, the pump inlet is also connected through a valve to a through-the-hull seawater inlet or sea chest 13. The outlet of the pump is connected through another valve to the inlet of a unified filter vessel 14 and also connected to a bypass line 15 and through another valve to an outlet connected for overboard discharge. The unified filter vessel 14 has a filtrate outlet 16 connected through a flow meter 17 to another valve to the ballast tank return line 18 and also through a valve to the overboard drain line 19. The unified filter vessel 14 also includes a backwash outlet line 20 connected through another valve to the overboard drain line 19.

Referring to FIG. 2, the unified filter vessel 14 is illustrated as having a plurality of filter media tubes 22 disposed in the pressure vessel 23 with the interior of each tube communicating through a bulkhead 24 to an inlet plenum 25 connected to the valve 26 which has its inlet connected to the pump 11. The pressure vessel has a filtrate outlet 16 which receives flow exiting through the filter media elements from the interiors thereof which communicate with the plenum 25. A second bulkhead 27 isolates the opposite ends of the filter media from a chamber 28 such that the interior of the filter media tubes 22 are isolated from the outlet 16. In operation, when the arm 29 is rotated to be aligned with any one of the filter media tubes 22, the lower pressure, typically atmospheric, of the drain line 20 when opened causes the pressure in the chamber connected to the outlet 16 to backwash the selected tube through arm 29 to the outlet 20. During backwashing of any particular tube, filtrate continues to flow from the plenum 25 through the filter media tubes 22 to the outlet 16. The filters are, thus, individually backwashed in sequence by rotation of arm 29 until all of the filters have been cleaned. This arrangement, thus, permits only a fraction of the filtrate flow to be diverted for backwashing and permits continuing filling of the ballast tanks.

When the ballast tanks have been filled, the backwashing cycle may be continued until completed. However, as only one filter media element is backwashed for a given position of the backwash arm, the remaining filter media elements will continue to be caked with retained foreign material including organic species. Thus, it has been desired to provide a way or means of minimizing the accumulation of filtered material on the filter media elements during the backwash sequence.

### SUMMARY

The present disclosure provides a filtering system for filling and emptying seawater ballast tanks and includes a filtration system for unified filter vessel having a multiplicity of individual filter media elements for filtering seawater entering the ballast tanks. The unified filter vessel includes a backwashing function for sequentially backwashing each of the filter media elements while permitting flow of filtrate through the remaining elements to the ballast tank. The filtration system of the present disclosure includes a recycle line connecting filtrate flow from the unified pressure vessel to the inlet of the pumps supplying seawater to the unified filter vessel. This arrangement minimizes the flow of raw seawater to the filter media elements during the backwashing sequence and, thus, provides cleaner fluid for performing the backwashing.

### BRIEF DESCRIPTION OF THE DRAWINGS

FIG. 1 is a system schematic of the backwashing filtration system of the present disclosure;

FIG. 2 is a cross-section of a unified filter vessel of the prior art which may be employed in the system of FIG. 1; and,

FIG. 3 is a schematic of a prior art seawater ballast filtration system.

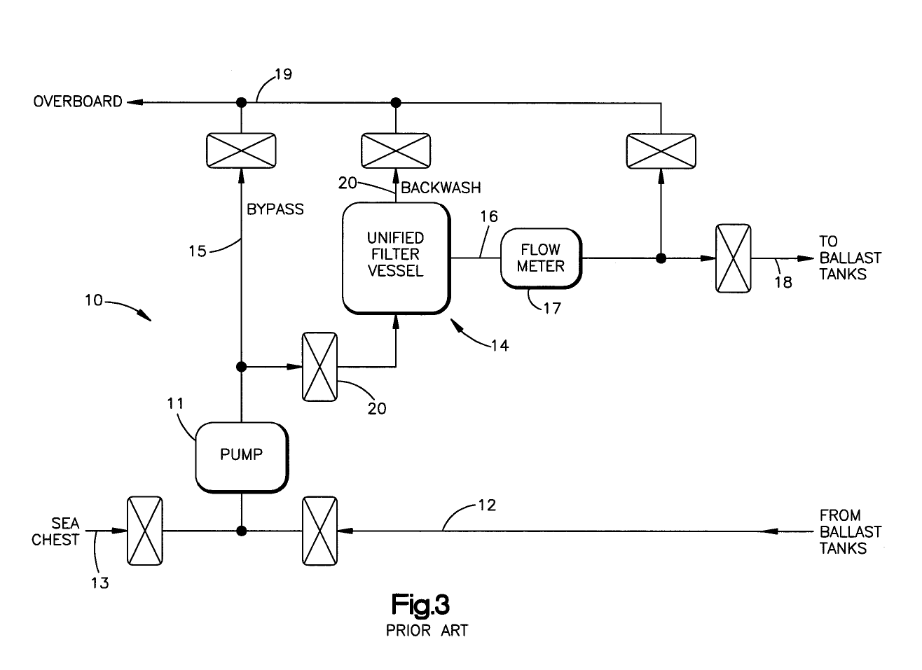

### DETAILED DESCRIPTION

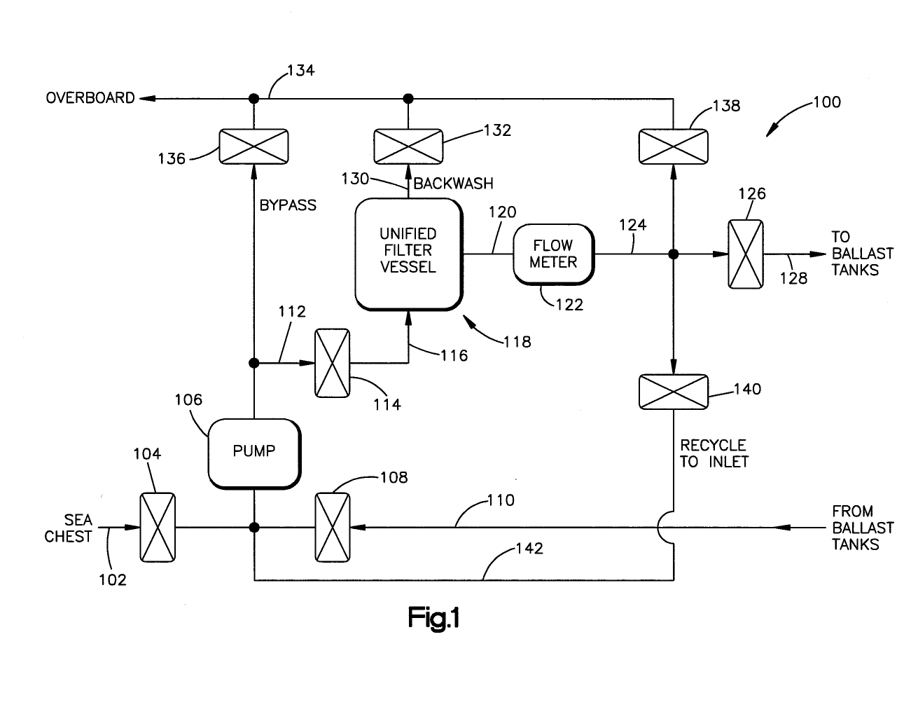

Referring to FIG. 1, a fluid filtering system in accordance with the present disclosure is indicated generally at 100 of the type employed for filtering seawater in on board ballast tanks and includes a through the hull seawater inlet line or sea chest 102 connected through a valve 104 to the inlet of a pump 106. The pump inlet is also connected through another valve 108 to an inlet line 110 connected to receive flow from an on board ballast tank (not shown).

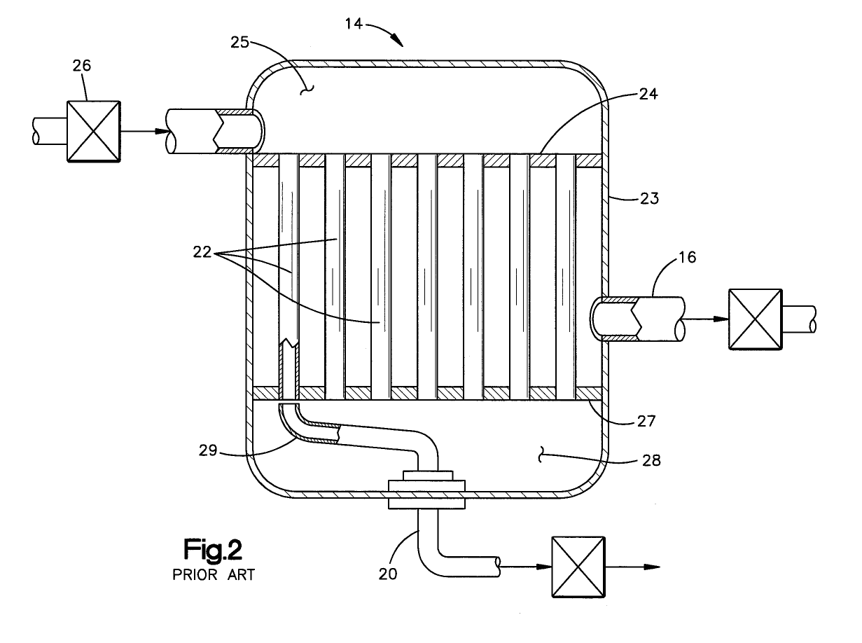

The pump outlet is connected through a line 112 and through another valve 114 to the inlet line 116 of a unified filter vessel indicated generally at 118; and, it will be understood that the unified filter vessel 118 may be similar to the filter 14 of FIG. 2.

The filtrate outlet of the unified filter vessel 118 flows through outlet line 120 and through a flow meter 122 and through line 124 and another valve 126, the outlet of which is connected to a line 128 for carrying filtrate to the inlet of an onboard ballast tank (not shown).

The backwash outlet line or drain line 130 of the filter vessel 118 is connected through another valve 132, the outlet of which is connected to a drain line 134 which may be an overboard drain.

The outlet line 112 of the pump 106, if desired, may also be connected through another valve 136, the outlet of which is connected to the overboard drain line 134.

The outlet of flow meter 122 through line 124 may also be connected through another valve 138 to the overboard drain line 134.

The outlet line 124 of the flow meter is also connected through a valve 140 to a recycle line 142 which is also connected to the inlet of the pump 106.

During the backwashing sequence of the unified filter vessel 118, typically when valve 126 is closed, valve 140 may be opened to provide a flow clean filtrate flow to the pump such that flow to the inlet of the pump comprises a mixture of seawater from valve 104 and clean filtrate from line 142 thereby minimizing the buildup or clogging of the remaining filter elements during the backwashing sequence.

The present disclosure thus describes a fluid filtration system and particularly for filling onboard seawater ballast tanks employing a unified filter pressure vessel having a multiplicity of individually replaceable filter media elements. The unified pressure vessel employed is of the type providing for sequentially backwashing of the individual filter elements and also provides for recycling of clean filtrate during the backwashing sequence to minimize buildup of foreign material on the filter media elements during the backwashing sequence.

Obviously, modifications and alterations will occur to others upon reading and understanding the preceding detailed description. It is intended that the exemplary versions described herein be construed as including all such modifications and alterations insofar as they come within the scope of the appended claims or the equivalents thereof.

1. A fluid filtering system with backwashing comprising:
(a) a pump having an inlet connected to a source of fluid to be filtered and an outlet;
(b) a fluid pressure vessel having an inlet, a filtered fluid outlet and a backwash discharge outlet and having fluid filtering media therein operable to filter flow from the inlet to the outlet and including backwash apparatus selectively operable to progressively backwash a portion of the filter media and maintain flow of filtrate from the inlet to the outlet through the remaining portions of the filter media during the backwashing of the selected portion;
(c) a first conduit connecting the pump outlet to the pressure vessel inlet, the first conduit having a valve therein;
(d) a second conduit connecting the pressure vessel filtered fluid outlet to a filtered fluid receiver; and,
(e) a recycle conduit connecting the second conduit through a valve to the pump inlet.

2. The system of claim 1, wherein the second conduit includes a valve.

3. The system defined in claim 1, wherein the backwash discharge outlet is connected through a valve to a drain.

4. The system defined in claim 1, wherein the pump inlet is connected through a valve to the source of fluid to be filtered.

5. The system of claim 1, wherein the first conduit includes a bypass from the pump outlet through a valve to a drain.

6. The system of claim 1, wherein the second conduit is connected through a valve to a drain.

7. The system of claim 1, wherein the pump inlet is connected through an inlet valve to a ship's sea chest; and, the second conduit is connected to a ballast tank inlet.

8. The system of claim 7, wherein the ballast tank has an outlet connected through a ballast valve to the pump inlet.

9. A method of filtering ballast tank water in a seagoing vessel comprising:
(a) providing a pump and connecting an inlet of the pump to a valve;
(b) providing a filter vessel having an inlet, a filtrate outlet and a filter media therein, the filter vessel including apparatus for progressively backwashing selected portions of the filter media while maintaining filtering flow through the remaining portions of the media and having a backwash drain outlet and connecting the inlet to an outlet of the pump;
(c) connecting the filtrate outlet to an inlet of the ballast tank;
(d) connecting an outlet of the ballast tank to the pump inlet;
(e) connecting the filtrate outlet to a recycle conduit and connecting the recycle conduit to the pump inlet; and,
(f) controlling the flow to the pump inlet such that the majority of the flow to the vessel inlet comprises flow from the recycle conduit.

10. The method of claim 9, further comprising connecting the backwash drain outlet to a seacock.

11. The method of claim 9, further comprising connecting the pump outlet to a seacock.

12. The method of claim 9, wherein connecting the filtrate outlet to a ballast tank includes connecting the filtrate outlet to a flow meter.

13. The method of claim 12, further comprising connecting an outlet of the flow meter through a valve to the ballast tank inlet.

14. The method of claim 9, wherein connecting the filter vessel inlet to an outlet of the pump includes connecting through a valve.

15. The method of claim 9, further comprising disposing a valve in the recycle conduit.
